(19) United States
(12) Patent Application Publication
(10) Pub. No.: US 2015/0347438 A1
(43) Pub. Date: Dec. 3, 2015

(54) TOPIC AUTHORITY SUGGESTIONS

(71) Applicant: Facebook, Inc., Menlo Park, CA (US)

(72) Inventors: Khalid El Arini, Menlo Park, CA (US); David Vickrey, Menlo Park, CA (US)

(21) Appl. No.: 14/586,476

(22) Filed: Dec. 30, 2014

Related U.S. Application Data
(60) Provisional application No. 62/004,787, filed on May 29, 2014.

(51) Int. Cl. G06F 17/30

(52) U.S. Cl. CPC G06F 17/3097; G06F 17/30867; G06Q 50/01

(57) ABSTRACT

Exemplary methods, apparatuses, and systems determine first and second entities within a social networking system are each associated with a topic. A relationship between the first entity and the second entity is detected. The first entity is determined to be an authority on the topic based upon the detected relationship between the first entity and the second entity. In response to detecting an indication that a user of the social networking system may be interested in the topic, the user is presented with content posted to the social networking system by the first entity based upon determining the first authority is an authority on the topic.

### CROSS-REFERENCE TO RELATED APPLICATIONS

This application claims the benefit of U.S. Provisional Application No. 62/004,787, filed May 29, 2014, which is hereby incorporated by reference.

### FIELD

Embodiments of the invention relate to social networking. In particular, embodiments relate to determining an authority on a topic and making content suggestions or otherwise presenting content from the topic authority to a user of a social networking system.

### BACKGROUND

A social networking system may present a user with content resulting from actions by or about the user's social networking connections and from entities with which the user has previously interacted. For example, a user may see a post made by a social networking connection or an update by a celebrity the user follows on the social networking system. This feed is valuable for a social networking system as it engages users quickly and conveniently with content in which they are interested.

### BRIEF DESCRIPTION OF THE DRAWINGS

The invention may best be understood by referring to the following description and accompanying drawings that are used to illustrate embodiments of the invention. In the drawings:

FIG. 1 illustrates a portion of an exemplary social networking system to suggest content to users according to embodiments of the invention;

FIG. 2 illustrates an example of a graph of social network data used to determine a topic authority;

FIG. 3 is a diagram illustrating exemplary user engagement within the social graph used to determine a topic authority;

FIG. 4 illustrates an exemplary topic authority database to store, maintain, and provide topic authorities and associated suggested content;

FIG. 5 illustrates an exemplary user interface of a social networking system including user engaged content and automatically suggested content;

FIG. 6 illustrates a method for determining a topic authority and presenting suggested content to a user according to an embodiment of the invention;

FIG. 7 illustrates, in block diagram form, an exemplary network service, such as a social network to determine related content to suggest to a user; and

FIG. 8 illustrates, in block diagram form, an exemplary processing system to determine related content to suggest to a user or to receive the related content.

### DESCRIPTION OF EMBODIMENTS

In the following description, numerous specific details are set forth. However, it is understood that embodiments of the invention may be practiced without these specific details. References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Additionally, as used herein, the term “exemplary” refers to embodiments that serve simply as an example or illustration. Moreover, such phrases are not necessarily referring to the same embodiment. Furthermore, when a particular feature, structure, or characteristic is described in connection with an embodiment, it is submitted that it is within the knowledge of one skilled in the art to affect such feature, structure, or characteristic in connection with other embodiments whether or not explicitly described.

In social networking systems, users interact with objects, such as topics, locations, and pages (e.g., pages representing entities, such as businesses, brands, organizations, and to which users can connect by, for example, “liking” the page). Objects represent various types of content. Examples of content represented by an object include a page post, a status update, a photograph, a video, a link, a shared content item, a check-in event at a local business, etc. Objects represent single pieces of content, or content “items.” A content item may be an image, photo, video, article, comment, post, etc. Topics are objects that have been tagged with ontological meaning. For instance, pages that are related to Wikipedia® entities are topics. More generally, topic objects can refer to single entities such as concepts (e.g., philosophical concepts or arguments), activities (e.g., hiking, skiing, swimming), or public entities (e.g., sport clubs, celebrities, politicians, etc.). In one embodiment, the social networking system maintains a relationship between objects of the social networking system and topics. For example, the social networking system may use meta-page clustering to cluster objects of the social networking system around a specific topic, thereby maintaining a relationship between the objects of the social networking system and the specific topic. For instance, equivalent concepts expressed across multiple pages may be matched and associated with a meta page or a topic as further described in U.S. patent application Ser. No. 13/295,002 filed on Nov. 11, 2011, and in U.S. patent application Ser. No. 13/295,001 filed on Nov. 11, 2011, each of which is hereby incorporated by reference in its entirety. In another example, the social networking system may apply topic tagging processes to maintain a relationship between objects and topics. For example, the social networking system maintains a relationship between an object and a topic based on the semantic content of a content item, such as a post, a message or a comment, associated with an object of the social networking system. In another example, relationships between objects may be formed, and objects can be grouped and connected based on similar categories or topics identified in the pages as further described in U.S. patent application Ser. No. 13/312,912 filed on Dec. 6, 2011, which is hereby incorporated by reference in its entirety.

Users of the social networking system include individuals and other entities, such as businesses or organizations. An entity can establish a presence on the social networking system for connecting and exchanging content with other social networking system users. For example, the entity may post information about itself, about its products, or provide other information to users of the social networking system using a page associated with the entity's user profile.

A social networking system or other network service may display or otherwise present a user with content with which other users have interacted. For example, a social networking system may present a user with a feed of content items with which the user's connections have shared, liked, created, etc. in the form of posts, comments on posts, etc. Additionally, the social networking system may present the user with content items based upon trending topics. As used herein, a trending topic refers a topic determined by the social networking system to be the subject of a large number of posts or other social networking system actions taken within a period of time. For example, when a threshold number of users of the social networking system include a specific content item (such as a string of text, article, etc. about a particular subject matter) in posts published within a threshold period of time, the social networking system designates the topic of the specific content item as a trending topic.

Various embodiments described herein determine topic authorities to present or suggest content to the user. In particular, embodiments determine an entity is an authority on a topic, e.g., based upon the common engagement of one or more other users with the entity and with another entity associated with the topic. In some embodiments, an entity is determined to be an authority on a topic based upon a personal or professional relationship between the entity and another entity that is a subject of the topic.

Various embodiments described herein utilize determined topic authorities to suggest or otherwise present users with content associated with the corresponding topics and determined topic authorities. Some embodiments suggest content on the topic from the determined topic authority in response to user interaction with a content item or other object related to a given topic. For example, embodiments may suggest content on the topic that was created or shared by the topic authority in response to the user interacting with an article or another object on the topic. Additionally, some embodiments include content on the topic that was created or shared by the topic authority in response to determining that the topic is a trending topic. For example, embodiments may present content associated with a topic authority to a user in response to the user selecting the topic from a list of trending topics. As a result of the determination of topic authorities, the user is presented with content with which the user is likely to engage.

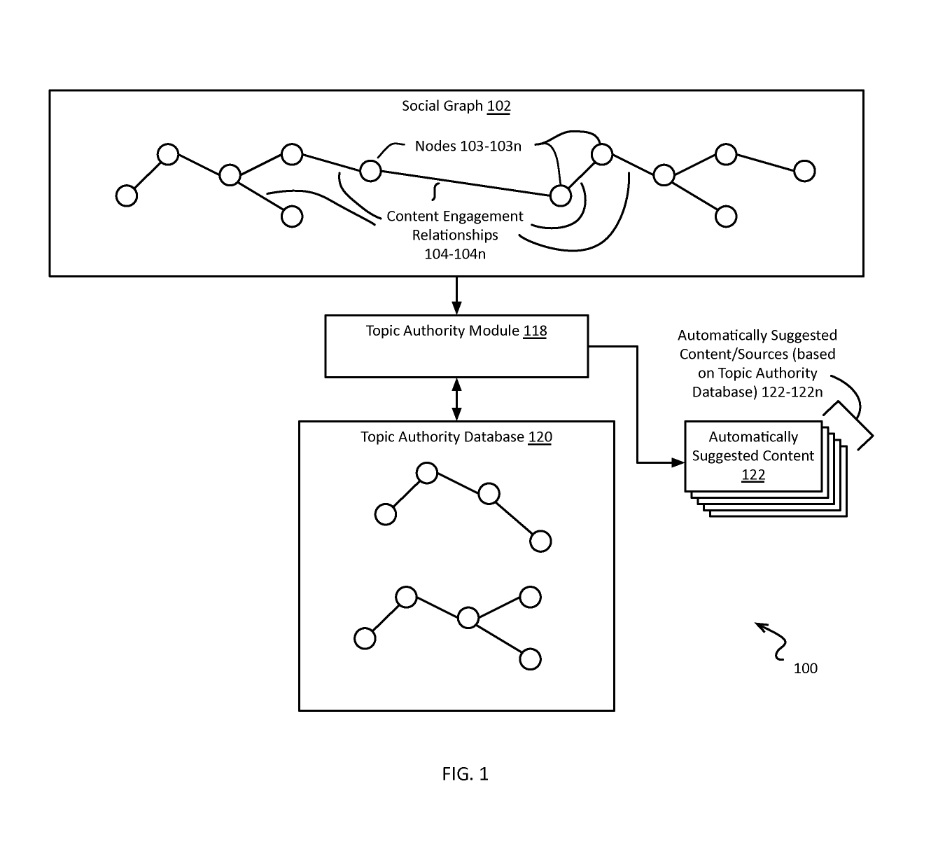

FIG. 1 illustrates a portion of an exemplary social networking system 100 including a topic authority module 118 to suggest content to users according to embodiments of the invention. While the figures and corresponding examples are described with reference to a social network or social networking system, the embodiments described herein, however, are not so limited and may apply to other network services that suggest content to users.

Social networking system 100 includes social graph 102. Social graph 102 includes a plurality of nodes 103-103n interconnected by a plurality of edges 104-104n. Each node 103 in the social graph 102 represents a user/entity or another object that can act on another node 103 and/or that can be acted on by another node 103. Each edge 104 between two nodes 103 in the social graph 102 represents a particular kind of connection between the two nodes 103, which may result from an action that was performed by one of the nodes 103 on the other node 103. For example, edges may represent a plurality of entity engagements 104 with content items. Exemplary entity engagements 104 include, but are not limited to, likes, comments, shares, clicks, follows, check-ins, selecting content to be removed, ratings, messages, etc.

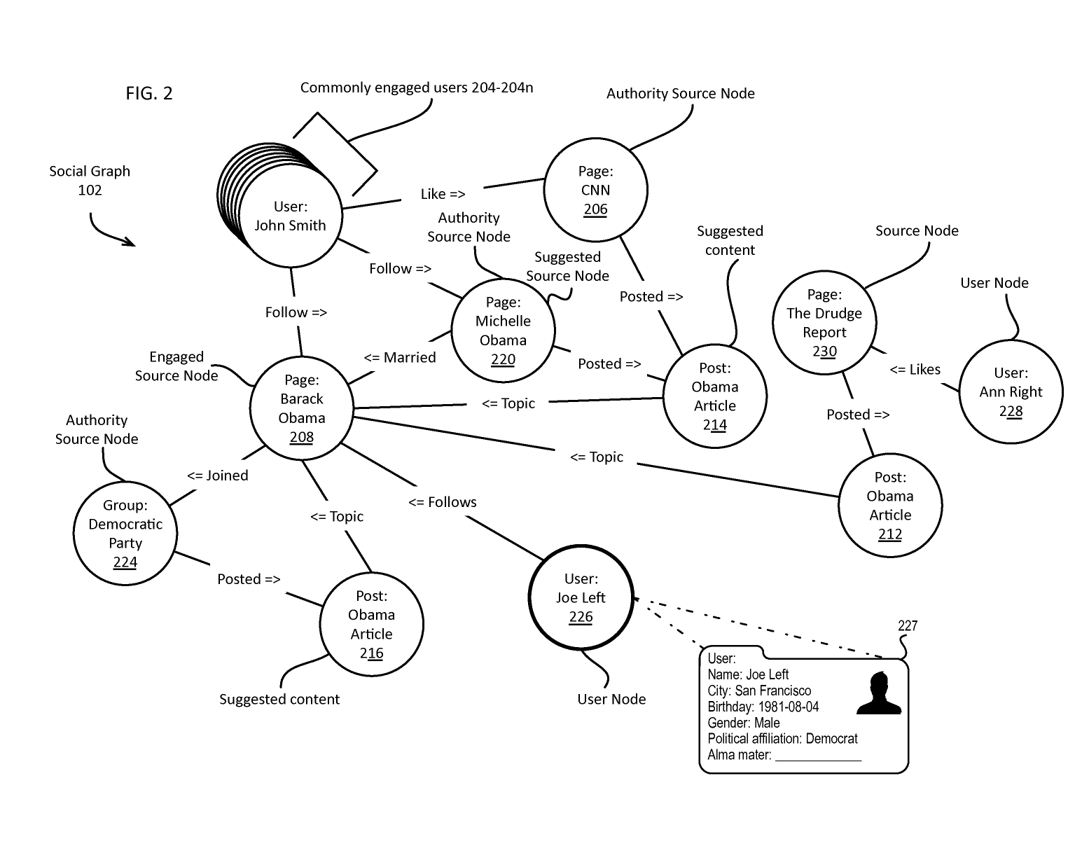

A like occurs when a user affirmatively endorses a particular content item or entity. A comment occurs when a user or entity posts a text, image, audio, or video message regarding a particular content item or entity. A share occurs when a user/entity notifies another user/entity about or otherwise publishes a content item. For example, the user/entity may post or repost a link to another website. A click is a user/entity interaction by which a user/entity clicks or copies a link associated with the content. A follow occurs when a user/entity indicates a desire to be notified of new activity made by an entity. For example, if a new post is created on the social networking page associated with the followed entity, that post may automatically be shown to the user/entity in a feed or other portal including the publication of content (collectively referred to herein as “feed”). A check-in occurs when a user indicates that he or she is/was at a particular physical location represented by an entity. Additionally, content presented to a user/entity, e.g., within a feed, may be selected or flagged to be removed or filtered out by content type. Social graph 102 is described further with reference to FIG. 2.

Social networking system 100 further includes topic authority module 118. In some embodiments, the topic authority module 118 determines relationships between content and/or entities. For example, topic authority module 118 mines the social graph 102 to determine engagement or other relationships between different objects as represented by nodes 103. In some embodiments, the topic authority module 118 determines that an entity is an authority with respect to a topic.

In one embodiment, the social networking system 100 determines a first entity associated with a topic to be an authority on the topic based upon a relationship between the first entity and a second entity associated with the topic. In one embodiment, the relationship includes common user engagement with the first and second entities. For example, common engagement by a user may include the user liking, following, being a fan of, or otherwise engaging with both the first entity and the second entity. If a threshold number or percentage of users has engaged with both the first and second entities, this common engagement is used as an indication that the first entity is an authority on the topic associated with the second entity. In some embodiments, the topic authority module 118 determines the first entity to be an authority on a topic associated with the second entity based upon a personal or professional relationship between the first and second entities. For example, if the first and second entities are spouses, the first entity may be determined to be an authority on a topic associated with the second entity. In some embodiments, topic authority module 118 stores and maintains determined topic authorities and authority relationships in topic authority database 120. Additional details and examples of determining and storing representations of topic authorities are described herein with reference to FIGS. 2, 3, 4, and 6.

In one embodiment, the topic authority module 118 suggests content posted by or otherwise associated with a topic authority in response to user engagement with content on the topic, user engagement with an entity associated with the topic, or a determination that the topic is trending. For example, suggested content 122 associated with a topic authority (e.g., content created/shared by the authority or a page or other representation of the topic authority itself) is presented to a user in response to the user's engagement with other content on the topic. In one embodiment, the social networking system detects the topic is trending or the subject of user engagement and looks up the topic authority in topic authority database 120 and presents content on the topic that was posted by the topic authority. The suggestion of content based upon a topic authority is described further with reference to FIGS. 2, 5, and 6.

FIG. 2 illustrates an example of a portion of social graph 102 according to an embodiment of the invention. As described above, objects (including entities and content) are represented as nodes in social graph 102. Social graph 102 includes user nodes 226 and 228, a set of commonly engaged user/entity nodes 204-204n, and plurality content item nodes. A user node of the social graph 102, in some embodiments, corresponds to an individual user of the social networking system 100. The user nodes may each include information provided by the corresponding user and/or gathered by various systems, including the social networking system 100. For example, user 226 provided his name, profile picture, city of residence, birth date, gender, and political affiliation in profile 227. User profiles may further include marital status, spouse or significant other, family status, employment, educational background, preferences, interests, and other demographic information/user characteristics to be included in or referenced by the user node. In one embodiment, for demographic or other information that has not been entered by a user, a social network application generates an estimate based upon the user's actions, connections, and/or actions of connections. For example, Joe Left 226 has not entered an alma mater into user profile 210. A social network application may determine from Joe Left's contacts, activities, cities of residence, etc. that Joe Left's likely alma mater is Stanford University.

Each entity node, such as nodes 206, 208, 220, 224, and 230, may represent a person, a celebrity, corporation, organization, group, thing, concept, topic, an animal, a movie, a song, a sports team, a restaurant, a place, a location, an album, an article, a book, a food, a website, etc. An entity may have a set of one or more “administrative” users that are granted permission to create or update the page or other information that represents the entity within the social networking system 100, e.g., by providing information related to the entity, posting content, interacting with content, etc.

Each content item node, such as nodes 212, 214, and 216, represents content created, shared, liked, posted by and/or otherwise interacted with by an entity. For example, the entity node 206 representing the news organization, CNN, posted an article, represented by content item node 214, about the topic of Barack Obama. As described above, exemplary content items include a post, a comment, an image, an audio item, a video item, a media item, a link, an event notification, a page, etc. The content item may be created, shared, or otherwise posted by an entity or the administrators for the entity.

Interactions or engagement with (e.g., likes, shares, posts, etc.) and other associations between (e.g., relationships, topic labels, etc.) objects are represented as edges or connections between the nodes. For example, an edge between two user nodes can represent a friendship or other connection between two users. As illustrated, each edge has an associated label, which describes the engagement/association relationship between the nodes. For example, an edge between a user node and a source node may have a label indicating that the user follows, likes, or otherwise has engaged with an entity. This may occur when the user clicks on a like indicator on a page displayed as a representation of the entity. As a further example, an edge between a content item and an entity may have a label indicating that the entity is a topic of the content item. As illustrated, the entity, Barack Obama, as represented by entity node 208, is the topic of three different articles 212, 214, and 216 posted to the social networking system. While examples set forth herein may refer to an entity represented by an entity node as a topic, embodiments may include a topic that is not an entity but otherwise associated with an entity. For example, the topic of articles 212, 214, and 216 may be “the President of the United States” or “the White House,” which are associated with Barack Obama, the current President, as represented by entity node 208 for Barack Obama.

In the exemplary social graph 102, user node 226 represents user “Joe Left.” Joe 226 has engaged with the entity node 208 representing President Barack Obama. In particular, Joe 226 has elected to follow Barack Obama's page 208 and, as a result, receives alerts of or is otherwise presented with posts made by Barack Obama's page 208.

The exemplary social graph also includes nodes 204-204n, each representing users that have also engaged with Barack Obama's page 208. For the ease of illustration, a single edge is drawn between the nodes 204-204n and the entity node for Barack Obama 208. The users represented by nodes 204-204n have also commonly engaged with an entity node 220 representing Michelle Obama and the entity node 206 representing CNN.

In one embodiment, the social networking system creates edges between nodes based upon implied engagement. For example, if a user 204 has not engaged directly with the page for the entity, CNN, 206, but the user 204 has engaged with a threshold amount of content posted by, shared by, or otherwise associated with CNN 206, the social networking system may create an implied connection the user 204 and CNN 206. User engagement with an entity, as used herein, includes direct engagement and implied engagement.

In some embodiments, the social networking system 100 uses social graph 102 to determine if a first entity associated with a topic is an authority on the topic based upon common user engagement 204 with the first entity and a second entity associated with the topic. In one embodiment, common user engagement includes a threshold amount of overlap between users that engage with two or more entities. For example, topic authority module 118 may determine that users 204-204n are commonly engaged with Barack Obama 208, Michelle Obama 220, and/or CNN 206. As a result, topic authority module 118 determines that Michelle Obama 220 and/or CNN 206 are authorities on the topic of Barack Obama. In one embodiment, topic authority module 118 utilizes common user engagement to determine topic authorities for particular users. For example topic authority module 118 may determine that Michelle Obama 220 and/or CNN 206 are authorities on the topic of Barack Obama for users, such as Joe Left 226, that follow or otherwise engage with the entity, Barack Obama 208.

In one embodiment, topic authority module 118 assigns a common engagement value based upon an amount of commonly engaged users, an amount of engagement actions performed by the commonly engaged users, different types of engagement, and/or the recency of engagement. For example, the user engagement of following an entity may be given a higher common engagement value than the user engagement of simply clicking on a page for the entity or interacting with a single post by the entity. Similarly, recent interactions with a number of posts by the entity may be given a higher common engagement value that older interactions. In one embodiment, topic authority module 118 determines the group of commonly engaged users based upon those users that have engaged with each of the entities at common engagement values at or above a threshold value.

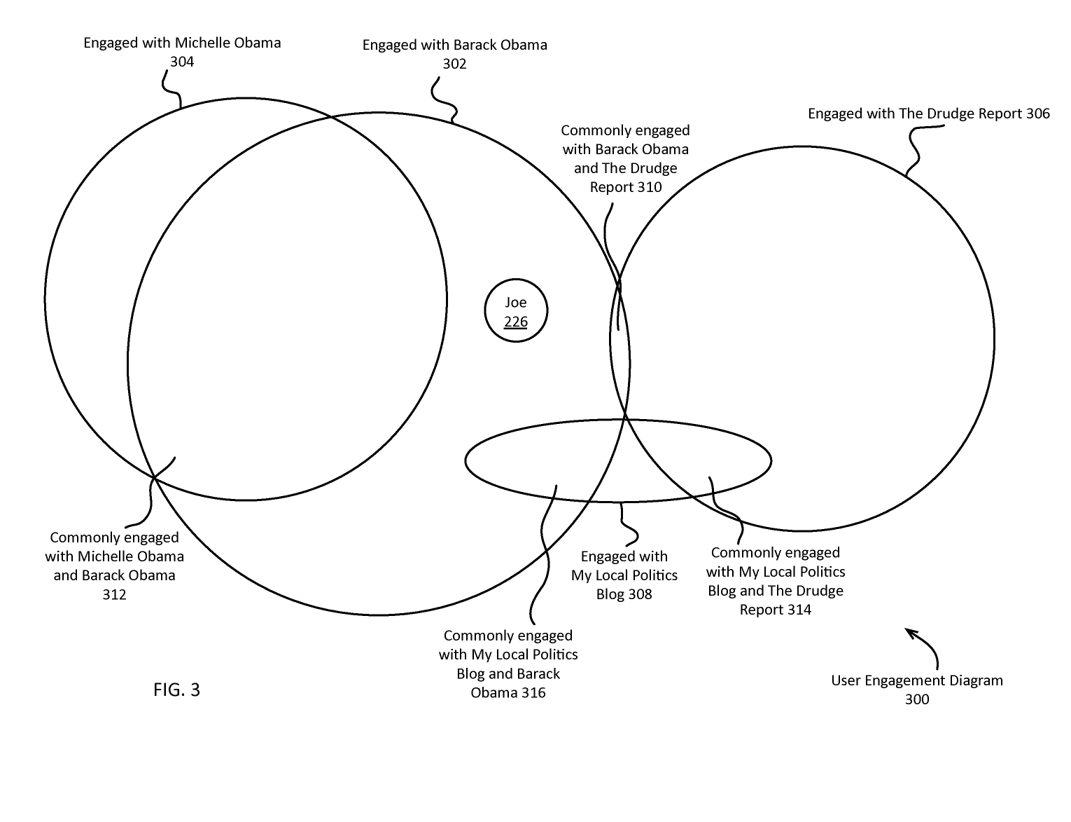

In one embodiment, topic authority module 118 normalizes the engagement overlap based upon the amount of engagement for each source. For example, overlapping engagement may be normalized or otherwise adjusted to account for the total engagement for each source. This normalization enables pages with a small amount of total engagement relative other sources but a large percentage of overlap within that total engagement to still be selected as an authority for a particular user. Engagement overlap is further described with reference to FIG. 3.

In one embodiment, topic authority module 118 further refines the determination of potential topic authorities based upon user or topic characteristics. For example, the profile 227 for Joe Left 226 includes demographic information that may be used to refine the selection of a topic authority when presenting suggested content to Joe Left 226. In such an embodiment, topic authority module 118 determines that all or a threshold number or percentage of commonly engaged users 204-204n share one or more user characteristics with Joe Left 226, in determining whether the common engagement is indicative of an entity being an authority on a topic when suggesting content on the topic to Joe Left 226. For example, a threshold number or percentage of commonly engaged users 204-204n may have a political affiliation with the Democratic Party. As a result, commonly engaged users 204-204n may be used to determine or select an authority on a topic, such as Barack Obama, when suggesting content for users that have a political affiliation with the Democratic Party, such as Joe Left 226. In some embodiments, refinement based on user characteristics is based on user actions and characteristics as described in U.S. patent application Ser. No. 13/800,633, which is hereby incorporated by reference in its entirety.

In one embodiment, topic authority module 118 utilizes topic authority database 120 or another data structure that provides authorities on particular topics or categories of topics. Topic authority module 118 determines that a given topic falls into particular category based upon a source/user node representing that topic or an external source, such as an online encyclopedia. For example, topic authority module 118 may determine that Tim Lincecum is a professional baseball pitcher for the San Francisco Giants by inspecting a social networking profile or page on Tim Lincecum, a social networking profile or page on the San Francisco Giants, or from a predetermined Internet resource external to the social network. Using San Francisco Giants, baseball, and/or sports as categories, topic authority module 118 selects an authority on one or more of those categories. For example, a sports news network such as ESPN, may have been previously determined to be an authority on baseball and/or sports generally, and therefore selected as an authority on the topic of Tim Lincecum.

In one embodiment, topic authority database 120 may include predetermined categories of authorities on particular topic categories. For example, a local news source may be listed as an authority on a local sports team. As a result, topic authority module 118 may search topic authority database 120 for a category of a topic, e.g., in response to the topic being within a list of one or more trending topics or the subject of user engagement. For example, a list of trending topics may include the topic of the San Francisco Giants. Topic authority module 118 determines the topic category for San Francisco Giants by searching category metadata within topic authority database 120 (e.g., determined from a social networking page on the San Francisco Giants or from a predetermined Internet resource external to the social network). As a result, topic authority module 118 determines that the San Francisco Giants are a sports team in San Francisco. Based upon a predetermined category of authorities, local news sources, that are authorities on this particular topic category, local sports team, topic authority module 118 determines that the San Francisco Chronicle is a local news source for San Francisco and therefore an authority on the San Francisco Giants.

In some embodiments, the social networking system 100 uses social graph 102 to determine if a first entity associated with a topic is an authority on the topic based upon another relationship between the first entity and the second entity associated with the topic, e.g., a personal or professional relationship between the entities. Based upon the determined relationship or other engagement between the entities, the first entity is utilized as an authority on a topic associated with the second entity. For example, the edge between the nodes for Michelle Obama 220 and Barack Obama 208 indicates that Michelle Obama is married to Barack Obama. Similarly, the edge between Barack Obama 208 and the Democratic Party 224 indicates that Barack Obama joined the group for the Democratic Party. As a result of identifying these relationships, topic authority module 118 may determine that Michelle Obama 220 and/or the Democratic Party 224 are authority source nodes on the topic of Barack Obama.

In one embodiment, topic authority module 118 presents a user with a page for or other content from a determined topic authority node for a given topic. For example, topic authority module 118 determines Joe Left 226 has engaged with a page or content for the topic, Barack Obama. As illustrated, Joe Left 226 follows the page for Barack Obama 208. Topic authority module 118 may further determine from a title, summary, hashtag, photo tag, or other article metadata that an article 214 posted by Michelle Obama 220 is on the topic of Barack Obama. In response to determining Michelle Obama 220 is an authority on Barack Obama, topic authority module 118 presents Joe Left 226 with a suggestion to read the article 214 on the topic of Barack Obama posted by Michelle Obama 220. Topic authority module 118 may additionally or alternatively present Joe Left 226 with a suggestion to engage with the page for Michelle Obama 220 based upon Michelle Obama posting the article 214 on the topic of Barack Obama. Similarly, in response to determining CNN 206 is an authority on Barack Obama, topic authority module 118 may present Joe Left 226 with a suggestion to read an article 214 on the topic of Barack Obama that was posted by CNN 206 or otherwise engage with the page for CNN 206. As another example, in response to determining the Democratic Party 224 is an authority on Barack Obama, topic authority module 118 may present Joe Left 226 with a suggestion to read an article 216 on the topic Barack Obama that was posted by Democratic Party 224 or otherwise engage with the page for Democratic Party 224.

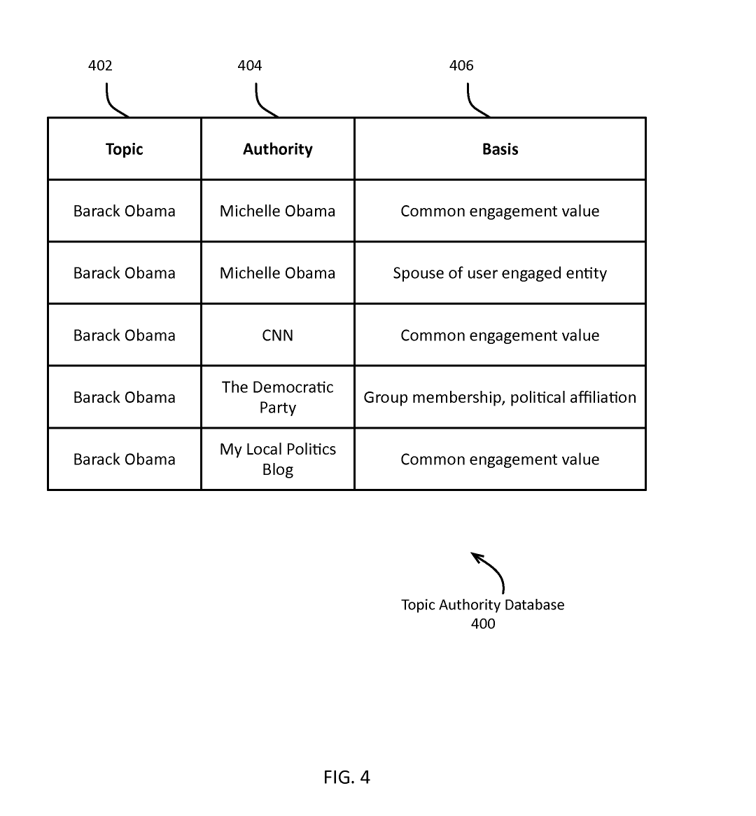

While the example illustrated in the social graph 102 is described with reference to particular pages representing corresponding entities being determined to be topic authorities, other sources of content may also be determined to be topic authorities and serve as sources of suggested content. For example, common user engagement with an advertisement may result in topic authority module 118 determining that the source of the advertisement is an authority. The common user engagement may be between a topic and a source of advertisements generally or between a topic and a particular advertisement. For example, topic authority module 118 may determine that there is an overlap in users that engage with a topic, such as automobiles, and users that engage with a source of advertisements, such as a manufacturer of automobiles. As another example, topic authority module 118 may determine that there is an overlap in users from Palo Alto, California that engage with a topic, such as automobiles, and a particular advertisement, such as an advertisement for the Tesla Model S. As a result, authority module 118 may select the advertisement content from an advertiser as an authority as suggested content for the user. Suggested sources and content are further described with reference to FIG. 4.

In contrast to the example suggestions above, the entity, The Drudge Report 230, posted an article 212 on the topic of interest, Barack Obama. While topic authority module 118 may have determined that The Drudge Report 230 is an authority on Barack Obama for one subset of users, topic authority module 118 may not have determined The Drudge Report 230 to be an authority on Barack Obama for another subset of users. For example, The Drudge Report 230 may lack in common engagement in a manner that corresponds to users like Joe Left 226. Users that engage with The Drudge Report 230 may not engage with Barack Obama 208 in a similar manner to Joe Left 226, may not share a user characteristic with Joe Left 226 (e.g., political affiliation), and/or The Drudge Report 230 may lack a relationship with Barack Obama 208 that would otherwise indicate an authority relationship for a user such as Joe Left 226. As a result, topic authority module 118 does not include The Drudge Report 230 or the corresponding article 212 as a suggestion for a user like Joe Left 226. Topic authority module 118, however, may include The Drudge Report 230 or the corresponding article 212 as a suggestion for other users, such as Ann Right 228.

As discussed above, in one embodiment, topic authority module 118 stores and maintains authority relationships in topic authority database 120 or other data structure. In such an embodiment, the determination of an authority source node described above may include mining the social graph 102 for a topic authority for a given topic based upon a relationship, such as common user engagement, and/or other metadata. Topic authority module 118 utilizes the results of mining the social graph 102 to present a suggested page or other content to the user. Additionally, topic authority module 118 stores the results of mining the social graph 102 in the topic authority database 120. Rather than mining the social graph 102 for the topic authority for each content suggestion, topic authority module 118 selects the topic authority from the topic authority database 120 and selects content on the topic posted by, shared by, or otherwise associated with the selected topic authority for presentation to one or more users. An example of the topic authority database 120 is further described with reference to FIG. 4.

FIG. 3 is a diagram illustrating exemplary user engagement 300 including a number of intersecting spaces that represent common user engagement with various entities within the social graph 102 according to an embodiment of the invention.

User engagement diagram 300 includes representations of a group of users 302 that have engaged with Barack Obama 208, a group of users 304 that have engaged with Michelle Obama 220, a group of users 306 that have engaged with The Drudge Report 230, and a group of users 308 that have engaged with My Local Politics Blog. User engagement diagram 300 also illustrates users that have commonly engaged with more than entity. For example, group 312 represents those users that have engaged with both Barack Obama 208 and Michelle Obama 220. Group 310 represents those users that have engaged with both Barack Obama 208 and The Drudge Report 230. Group 314 represents those users that have engaged with both The Drudge Report 230 and My Local Politics Blog. Group 316 represents those users that have engaged with both Barack Obama 208 and My Local Politics Blog.

As described above, Joe 226 is within the group of users 302 that have engaged with Barack Obama 208. Joe 226 has not engaged with Michelle Obama 220, My Local Politics Blog, or The Drudge Report 230. As a result, Joe 226 is not included in any of corresponding user groups 304-316. As discussed herein, however, users that have commonly engaged with Barack Obama 208 and another entity may be used to determine an entity is a topic authority (e.g., generally or for users like Joe 226) on the topic of Barack Obama. For example, topic authority module 118 may use the number or percentage of users within groups 310, 312, and 316 to determine whether The Drudge Report 230, Michelle Obama 220, or My Local Politics Blog should serve as an authority on topic of Barack Obama.

In one embodiment, topic authority module 118 normalizes the engagement overlap based upon the amount of engagement for each entity. This normalization enables topic authority module 118 to account for the total engagement for each entity. For example, topic authority module 118 may normalize the numbers of commonly engaged users as a percentage of one or more of the commonly engaged total groups. The group of users 316 that have commonly engaged with Barack Obama 208 and My Local Politics Blog is small in comparison to the group of users 312 that have commonly engaged with Barack Obama 208 and Michelle Obama 220. By treating the group of users 316 as a percentage of a total of all users that have engaged with My Local Politics Blog 308 and/or Barack Obama 302, topic authority module 118 is able to, e.g., utilize small groups of users with a large percentage of engagement as an indication of authority. Similarly, the number of commonly engaged users 312 between Barack Obama 208 and Michelle Obama 220 is high compared to the total number of engaged users for each of the two groups 302 and 304. Thus, the normalized common engagement for the Barack Obama 208 and Michelle Obama 220 is high. In contrast, the normalized common engagement for Barack Obama 208 and The Drudge Report 230 is low because of the low number of commonly engaged users 310 between The Drudge Report 230 and Barack Obama 208 as compared to the total number of engaged users for each of the two groups 302 and 306. As a result, the source Michelle Obama 220 is determined to be an authority on the topic of Barack Obama. On the other hand, the source The Drudge Report 230 may not be determined to be an authority on the topic of Barack Obama due to its low normalized common engagement.

FIG. 4 illustrates an exemplary topic authority database 400 to store, maintain, and provide authority entities and suggested content. Topic authority database 400 includes example entries based upon the description of FIGS. 2-3. In particular, as indicated by the topic column 402, topic authority database 400 includes multiple entries for the topic of Barack Obama. As indicated by the authority column 404 and basis column 406, each entry identifies a determined authority entity node for the corresponding topic and the basis for the determined authority. In one embodiment, an entry in the basis column 406 includes one or more common engagement values. Exemplary common engagement values include one or more numbers, percentages, weighted values (e.g., based upon the type or amount of engagement), and/or normalized values for the group of users engaged with each of the two or more commonly engaged entities.

Following the examples set forth in the description of FIGS. 2-3, topic authority module 118 determines from mining social graph 102 that Michelle Obama is an authority on Barack Obama based upon a threshold common user engagement 312 with both the entity, Michelle Obama 220, and the entity, Barack Obama 208. Topic authority module 118 further determines Michelle Obama is an authority on Barack Obama based upon Michelle Obama being the spouse of Barack Obama. Similarly, the Democratic Party is an authority on Barack Obama based upon Barack Obama's membership in the Democratic Party group. Additionally, topic authority module 118 may determine that Democratic Party is an authority on Barack Obama based upon Barack Obama's membership in the Democratic Party group for users having a political affiliation (as indicated by his/her user profile) with the Democratic Party or membership in the Democratic Party group. As illustrated in FIG. 2, Joe Left's profile 227 indicates that Joe Left 226 is affiliated with the Democratic Party. Based upon this affiliation, topic authority module 118 selects the source Democratic Party 224, e.g., from topic authority database 400, as an authority for Joe Left 226. As another example, topic authority module 118 is able to utilize topic authority database 400 to subsequently select or otherwise determine an authority 404 (e.g., a page for Michelle Obama) on a stored topic 402 (e.g., Barack Obama). In one embodiment, when a user engages with a source related to the topic of Barack Obama (e.g., engagement with the page for or content from the page for Barack Obama) or is to be presented with one or more trending topics including Barack Obama, topic authority module 118 selects authority 404 (e.g., a page for Michelle Obama) as an authority on that topic and presents or recommends content from authority 404 to the user.

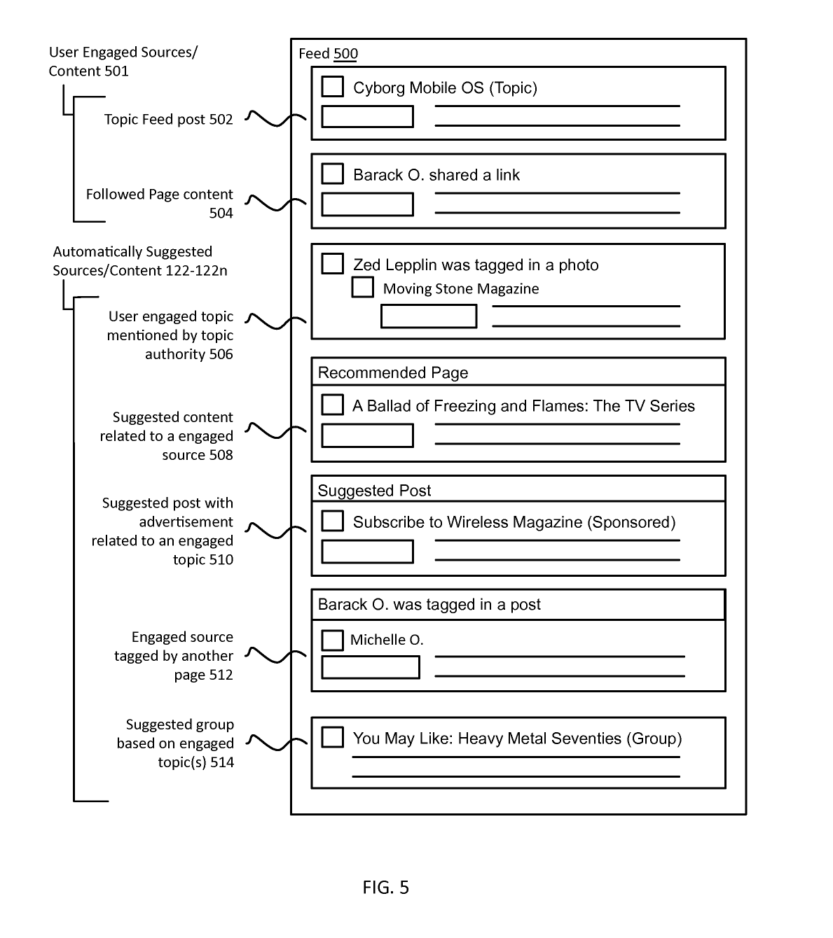

FIG. 5 illustrates an exemplary user interface 500 displaying a feed publication format of user engaged content 501 and automatically suggested content 122-122n. The user engaged content 501 includes content from entities with which the user has engaged. These include, but are not limited, to the examples shown. Topic feed post 502 is a post from the entity representing the topic of the “Cyborg” mobile OS. The user may have engaged with this topic by following the entity previously. Content 504 is a link shared by the entity Barack Obama and published in the user feed 500 as a result of the user previously indicating that he was a fan of or otherwise following Barack Obama. Other content from entities with which the user has engaged may also be displayed on the user's feed 500.

The feed 500 also includes automatically suggested content 122-122n based upon determined topic authorities. The suggested content 122-122n includes entities or content items associated with the entities, e.g., with which the user has not directly engaged. Instead, as described herein, the topic authority module 118 determined that these entities or corresponding content items are related to a topic of the user-engaged entities/content and presents them based upon determined topic authorities.

Suggested content 506 is an exemplary user interface element containing a post from “Moving Stone Magazine,” containing content related to a user engaged entity, the band “Zed Lepplin.” In some embodiments, the topic authority module 118 suggests post 506 to the user because the content item from Moving Stone Magazine is related to user engaged content, Zed Lepplin, and the entity, Moving Stone Magazine, is determined to be a topic authority on the band.

In one embodiment, the amount of user engagement that triggers the suggestion content or to engage with an entity varies based upon the type of the topic, amount of engagement, and/or the type of the entity or content with which the user engaged that triggered the suggestion. For example, users may indicate that they like a large number of bands, movies, books, and/or television shows, but not wish to receive suggestions based upon all of those engagements. In contrast, a user that engaged with a page for sports team may enjoy receiving suggestions related to the topic of that sports team. Topic authority module 118 may, therefore, trigger suggestions based upon a higher threshold of user engagement with some types of topics/content/entities than other types of topics/content/entities.

In one embodiment, the suggestion includes an indication of the topic authority entity that created or posted the suggested content. For example, the user interface element 506 states that the content item is related to the user engaged entity by stating that “Zed Lepplin was tagged in a photo” and includes a reference to the topic authority, Moving Stone Magazine. Through this indication, the user is made aware of why the post is placed on his or her feed.

The user presented with feed 500 has previously engaged with the entity representing the book “A Ballad of Freezing and Flames.” Suggested page for entity 508 represents the TV series adaptation of the book. In some embodiments, the topic authority module 118 determines that these two entities are related, e.g., by determining a threshold amount of common user engagement with the corresponding book and TV series pages.

Suggested content 510 is an exemplary user interface element suggesting a sponsored content item/advertisement to the user for the entity, “Wireless Magazine.” As illustrated, the user has engaged in the topic “Cyborg Mobile OS.” In some embodiments, the topic authority module 118 determines that the entity, “Wireless Magazine,” has generated this advertisement content item, is an authority for or otherwise related to the entity, “Cyborg Mobile OS.” This determination may be performed using the methods described herein, e.g., based upon users both being engaged with both “Cyborg Mobile OS” and the advertisement content item.

Suggested content 512 is an exemplary suggested content item based upon the examples described with reference to FIGS. 2-3. As described above, the topic authority module 118 determines that a relationship exists between the entity associated with the suggested content item (Michelle Obama) and the entity that is the subject of or otherwise associated with the topic (Barack Obama). In other words, the topic authority module 118 determines that Michelle Obama is an authority on Barack Obama and, as a result, suggests posts by Michelle Obama on the topic of Barack Obama.

Suggested group 514 is an exemplary user interface element suggesting a source representing the group “Heavy Metal Seventies” to the user. In some embodiments, the topic authority module 118, using the methods described herein, determines that the suggested group is an authority on the topic of an entity (e.g. the band “Zed Lepplin”) with which the user has engaged.

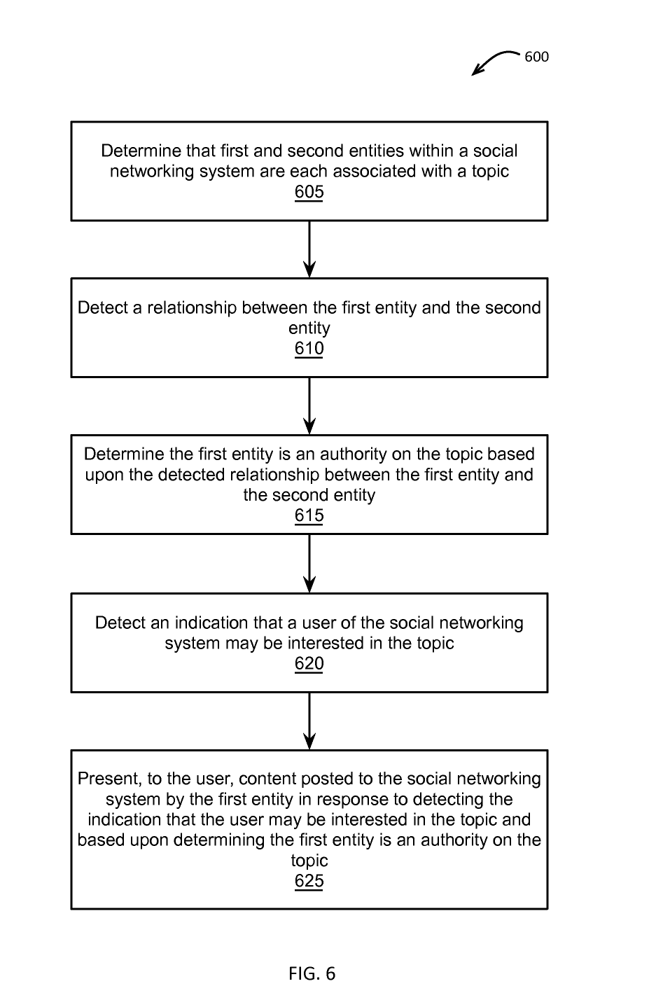

FIG. 6 is a flow chart illustrating an exemplary method 600 for determining a topic authority and suggesting content to a user according to an embodiment of the invention. At block 605, topic authority module 118 determines that first and second entities within a social networking system are each associated with a topic. Following the examples set forth herein, the entities, Barack Obama and Michelle Obama, are both associated with the topic, Barack Obama. The topic, Barack Obama, is associated with the entity Barack Obama due to both being linked to the same person, Barack Obama. The entity, Michelle Obama, posts content related to topic, Barack Obama, and represents the spouse of Barack Obama.

At block 610, topic authority module 118 detects a relationship between the first entity and the second entity. Exemplary relationships, as described above, include common user engagement between the first and second entities, personal/professional relationships between the first and second entities, etc.

At block 615, topic authority module 118 determines the first entity is a topic authority based upon the detected relationship between the first and second entities. For example, determining the first entity is an authority on a topic may be based upon detecting a threshold amount of common user engagement among users that have engaged with both the first entity and the second entity. As another example, determining the first entity is an authority on a topic may be based upon detecting another relationship between the first and second entities, e.g., a personal or professional relationship.

In one embodiment, topic authority module 118 stores the determined topic authority for future reference in suggesting content on the corresponding topic. For example, topic authority module 118 creates an entry in topic authority database 400 including the topic, the first entity as an authority on the topic, and the basis for determining the first entity as an authority on the topic.

At block 620, topic authority module 118 detects an indication that a user of the social networking system may be interested in the topic. Examples of this indication include the user engaging with content associated with the topic (e.g., the user clicking through to read an article on the topic, liking/sharing/posting an article on the topic, etc.) and the user selecting or otherwise viewing the topic within a list of one or more trending topics.

At block 625, topic authority module 118 presents, to the user, content posted by, shared by, or otherwise engaged by or associated with the first entity in response to detecting the indication of the user's (potential) interest in the topic and based upon the determination that the first entity is an authority on the topic. Continuing the examples above, a user's engagement with an article on the topic of Barack Obama may trigger topic authority module 118 to determine Michelle Obama is an authority on Barack Obama (e.g., based upon a search of topic authority database 400) and to present another article on the topic of Barack Obama that was posted by Michelle Obama as suggested content for the user. Similarly, the inclusion of Barack Obama as a trending topic may trigger topic authority module 118 to search topic authority database 400 and select Michelle Obama as an authority on Barack Obama.

In one embodiment, presenting suggested content includes ranking determined topic authorities and presenting one or more of the content items based upon the ranking. For example, a trending topic feed may include multiple content items on the topic. In such an embodiment, topic authority module 118 may present the multiple content items in an order based upon the ranking of the corresponding topic authorities that are associated with the content items. Alternatively, the content item presented to the user may be selected from multiple content items associated with multiple authorities on the topic based upon the rankings of the topic authorities. For example, the content item may be selected for presentation to the user based upon the associated topic authority being the top-ranked authority on the topic. In one embodiment, topic authorities are ranked on the type of relationship/basis used in determining the entity is an authority on the topic, the amount of common user engagement (total or normalized), how recent or the type of user engagement that contributed to the common user engagement, etc. A first authority on a topic that was determined based upon a greater common user engagement value may be ranked higher than a second authority on the topic that was determined based upon a lesser common user engagement value.

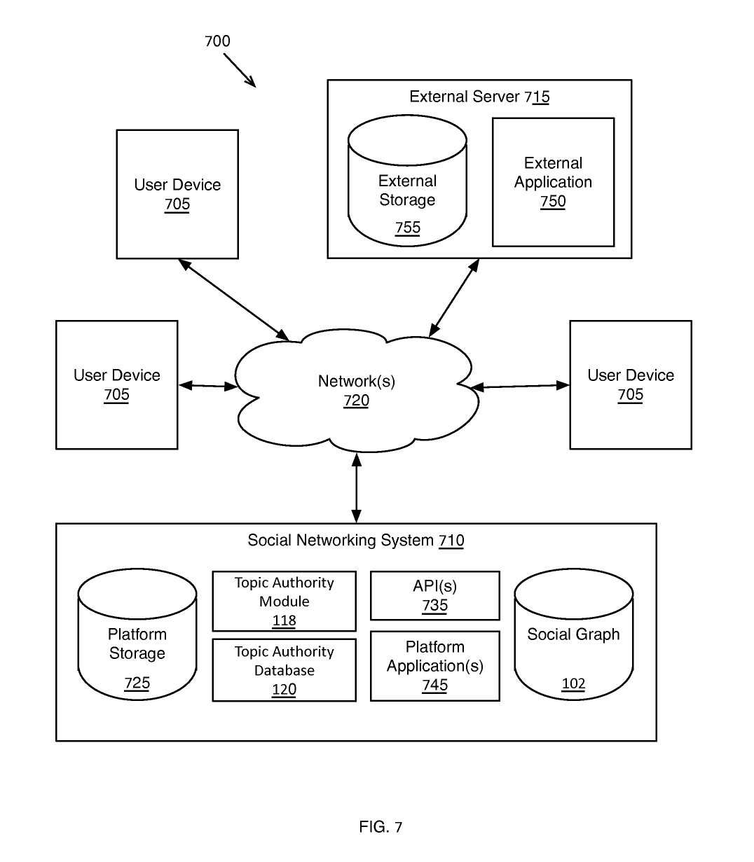

FIG. 7 illustrates, in block diagram form, an exemplary network service 700, such as a social network to facilitate determining related content to suggest to a user. Social network 700 includes user devices 705, social networking system 710, and external server 715 coupled to one or more networks 720. A user interacts with the social networking system 710 using a user device 705, such as a personal computer or a mobile phone. For example, the user device 705 communicates with the social networking system 710 via an application such as a web browser or native application. Typical interactions between the user device 705 and the social networking system 710 include operations such as viewing profiles of other users of the social networking system 710, contributing and interacting with media items, joining groups, listing and confirming attendance at events, checking in at locations, liking certain pages/posts, creating pages, and performing other tasks that facilitate social interaction, as described herein.

The social networking system 710 includes platform storage 725, a topic authority module 118, a topic authority database 120, one or more application programming interfaces (API's) 735, a social graph 102, and one or more platform applications 745. Platform storage 725 stores user preferences/settings, profile data, interaction data, object metadata, demographic data, etc. Exemplary platform applications 745 include the platform for social interactions (e.g., publishing posts, pictures, etc.) as well as social games, messaging services, and any other application that uses the social platform provided by the social networking system 710. While illustrated as a single block, social networking system 710 may include a plurality of servers and/or data stores.

In some embodiments, the topic authority module 118 and topic authority database 120, and/or a platform application 745 perform some or all of the methods described above. Interaction data, object metadata, demographic data, associations between entities and objects, etc. is received from platform storage 725 and/or the social graph 102, and the mappings are stored in platform storage 725. Alternatively, one or more of the method and/or data is performed/stored external to the social networking system 710. In some embodiments, topic authority database 120 is stored within platform storage 725.

One or more API's 735 enable external applications 750 to work with the social networking system 710. For example, an external application 750 utilizes an API 735 to authenticate a user based upon the user's social networking log in username and password. Additionally, an external application 750 utilizes one or more API's 735 to run the application within the platform application 745, to publish a post to the platform application 745, to access the user's social network connections within the social graph 102, etc. In one embodiment, an external application 750 implements a topic authority module 118 and performs method 600 and the corresponding data is received from and/or stored in one or both of external storage 755 or in platform storage 725.

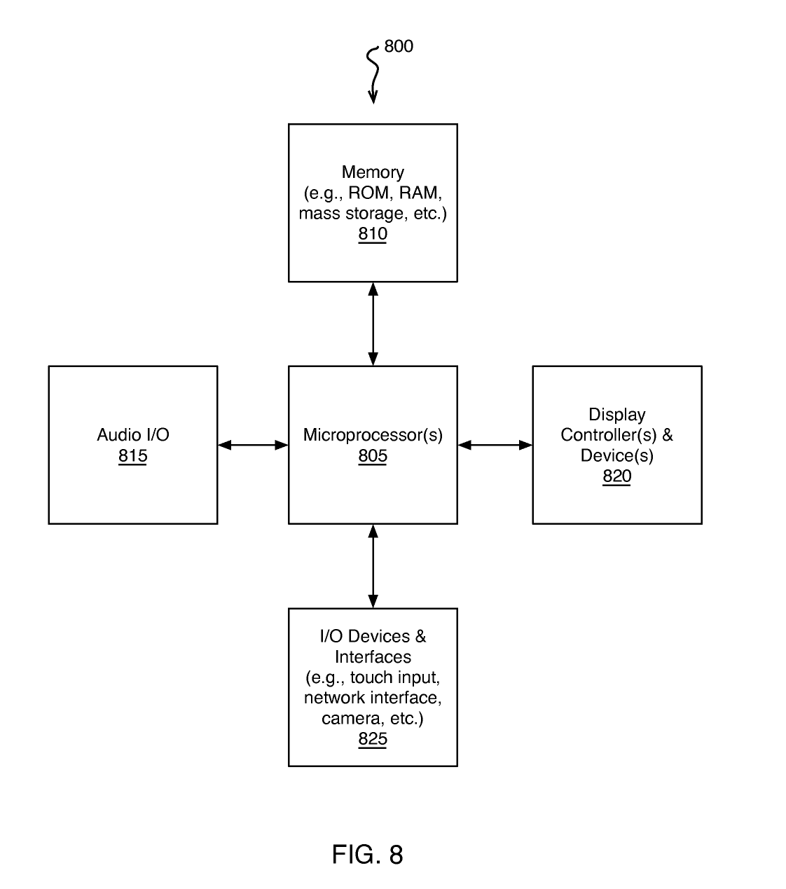

FIG. 8 illustrates, in block diagram form, an exemplary processing system 800 to facilitate determining related content to suggest to a user or receiving the related content. Data processing system 800 includes one or more microprocessors 805 and connected system components (e.g., multiple connected chips). Alternatively, the data processing system 800 is a system on a chip.

The data processing system 800 includes memory 810, which is coupled to the microprocessor(s) 805. The memory 810 may be used for storing data, metadata, and programs for execution by the microprocessor(s) 805. The memory 810 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 810 may be internal or distributed memory.

The data processing system 800 also includes an audio input/output subsystem 815 which may include a microphone and/or a speaker for, for example, playing back music or other audio, receiving voice instructions to be executed by the microprocessor(s) 805, playing audio notifications, etc. A display controller and display device 820 provides a visual user interface for the user.

The data processing system 800 also includes one or more input or output (“I/O”) devices and interfaces 825, which are provided to allow a user to provide input to, receive output from, and otherwise transfer data to and from the system. These I/O devices 825 may include a mouse, keypad or a keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 800.

The I/O devices and interfaces 825 may also include a connector for a dock or a connector for a USB interface, FireWire, Thunderbolt, Ethernet, etc. to connect the system 800 with another device, external component, or a network. Exemplary I/O devices and interfaces 825 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect the data processing system 800 with another device, external component, or a network and receive stored instructions, data, tokens, etc.

It will be appreciated that one or more buses, may be used to interconnect the various components shown in FIG. 8.

The data processing system 800 is an exemplary representation of one or more of user's device 705, at least a portion of the social networking system 710, or the external server 715. The data processing system 800 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, the data processing system 800 may be a network computer, server, or an embedded processing device within another device or consumer electronic product. As used herein, the terms computer, device, system, processing system, processing device, and “apparatus comprising a processing device” may be used interchangeably with the data processing system 800 and include the above-listed exemplary embodiments.

It will be appreciated that additional components, not shown, may also be part of the system 800, and, in certain embodiments, fewer components than that shown in FIG. 8 may also be used in a data processing system 800. It will be apparent from this description that aspects of the inventions may be embodied, at least in part, in software. That is, some or all of the computer-implemented methods described above may be carried out in a computer system or other data processing system 710/715/800 in response to its processor or processing system 805 executing sequences of instructions contained in a memory, such as memory 810 or other non-transitory machine-readable storage medium. The software may further be transmitted or received over a network (not shown) via a network interface device 825. In various embodiments, hardwired circuitry may be used in combination with the software instructions to implement the present embodiments. Thus, the techniques are not limited to any specific combination of hardware circuitry and software, or to any particular source for the instructions executed by the data processing system 800.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing a Field-Programmable Gate Array (FPGA), Application-Specific Integrated Circuit (ASIC), a processor, a computer, or a computer system, including a networked computer system. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. References in the specification to “one embodiment,” “an embodiment,” “an exemplary embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Furthermore, when a particular feature, structure, or characteristic is described in connection with an embodiment, such feature, structure, or characteristic may be implemented in connection with other embodiments whether or not explicitly described. Blocks with dashed borders (e.g., large dashes, small dashes, dot-dash, dots) are used herein to illustrate optional operations that add additional features to embodiments of the invention. However, such notation should not be taken to mean that these are the only options or optional operations, and/or that blocks with solid borders are not optional in certain embodiments of the invention. Numerous specific details are described to provide a thorough understanding of various embodiments of the present invention. However, in certain instances, well-known or conventional details are not described in order to provide a concise discussion of embodiments of the present inventions.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A method comprising:
determining first and second entities within a social networking system are each associated with a topic;
detecting a relationship between the first entity and the second entity;
determining the first entity is an authority on the topic based upon the detected relationship between the first entity and the second entity;
detecting an indication that a user of the social networking system may be interested in the topic; and
presenting, to the user, content posted to the social networking system by the first entity in response to detecting the indication that the user may be interested in the topic and based upon determining the first authority is an authority on the topic.

2. The method of claim 1, wherein detecting a relationship between the first entity and the second entity includes detecting a threshold amount of user engagement among users that have engaged with both the first entity and the second entity.

3. The method of claim 2, wherein determining the threshold amount of user engagement includes determining a total number of users that have engaged with both the first entity and the second entity.

4. The method of claim 3, wherein determining the threshold amount of user engagement includes adjusting the total number of users based upon a size of a total number of users that have engaged with the first entity.

5. The method of claim 2, wherein determining the threshold amount of user engagement includes an amount of engagement actions users have had with the content from the first source or content from the source authority.

6. The method of claim 2, wherein determining the threshold amount of user engagement includes applying weighted values to different engagement actions to calculate a total user engagement value, the weighted values based upon how recent the different engagement actions occurred and/or the type of each engagement action.

7. The method of claim 1, wherein detecting the relationship between the first entity and the second entity includes detecting a personal or professional relationship between the first entity and the second entity.

8. The method of claim 1, wherein the indication that the user may be interested in the topic is the user engaging with other content on the topic.

9. The method of claim 1, wherein the indication that the user may be interested in the topic is the inclusion of the topic among a list of one or more trending topics.

10. The method of claim 1, wherein the content posted by the first entity is presented further in response to the user engaging with the second entity.

11. A non-transitory computer-readable medium storing instructions which, when executed by one or more processors in a processing device, cause the processing device to perform a method comprising:
determining first and second entities within a social networking system are each associated with a topic;
detecting a relationship between the first entity and the second entity;
determining the first entity is an authority on the topic based upon the detected relationship between the first entity and the second entity;
detecting an indication that a user of the social networking system may be interested in the topic; and
presenting, to the user, content posted to the social networking system by the first entity in response to detecting the indication that the user may be interested in the topic and based upon determining the first authority is an authority on the topic.

12. The non-transitory computer-readable medium of claim 11, wherein detecting a relationship between the first entity and the second entity includes detecting a threshold amount of user engagement among users that have engaged with both the first entity and the second entity.

13. The non-transitory computer-readable medium of claim 12, wherein determining the threshold amount of user engagement includes determining a total number of users that have engaged with both the first entity and the second entity.

14. The non-transitory computer-readable medium of claim 13, wherein determining the threshold amount of user engagement includes adjusting the total number of users based upon a size of a total number of users that have engaged with the first entity.

15. The non-transitory computer-readable medium of claim 12, wherein determining the threshold amount of user engagement includes an amount of engagement actions users have had with the content from the first source or content from the source authority.

16. The non-transitory computer-readable medium of claim 12, wherein determining the threshold amount of user engagement includes applying weighted values to different engagement actions to calculate a total user engagement value, the weighted values based upon how recent the different engagement actions occurred and/or the type of each engagement action.

17. The non-transitory computer-readable medium of claim 11, wherein detecting the relationship between the first entity and the second entity includes detecting a personal or professional relationship between the first entity and the second entity.

18. The non-transitory computer-readable medium of claim 11, wherein the indication that the user may be interested in the topic is the user engaging with other content on the topic.

19. The non-transitory computer-readable medium of claim 11, wherein the indication that the user may be interested in the topic is the inclusion of the topic among a list of one or more trending topics.

20. The non-transitory computer-readable medium of claim 11, wherein the content posted by the first entity is presented further in response to the user engaging with the second entity.
